(19) United States
(12) Patent Application Publication
(10) Pub. No.: US 2010/0323925 A1
(43) Pub. Date: Dec. 23, 2010

(54) Nanosensor array for electronic olfaction

(76) Inventors: Jean-Christophe P. Gabriel, Pinole, CA (US); Vikram Joshi, Newington, CT (US); Sergei Skarupo, Berkeley, CA (US); Alexander Star, Pittsburgh, PA (US); David Thomas, San Francisco, CA (US)

Correspondence Address: Weaver Austin Villeneuve & Sampson LLP, P.O. BOX 70250, OAKLAND, CA, 94612-0250, US

(21) Appl. No.: 11/541,794

(22) Filed: Oct. 2, 2006

Related U.S. Application Data
(63) Continuation-in-part of application No. 10/945,803, filed on Sep. 20, 2004, now Pat. No. 7,449,757.
Application No. 10/945,803 is a continuation-in-part of application No. 11/488,456, filed on Jul. 18, 2006, now abandoned.
Application No. 11/488,456 is a continuation-in-part of application No. 10/940,324, filed on Sep. 13, 2004, now abandoned.
Application No. 10/940,324 is a continuation-in-part of application No. 10/656,898, filed on Sep. 5, 2003, now abandoned.
Application No. 10/656,898 is a continuation-in-part of application No. 11/139,184, filed on May 27, 2005, now Pat. No. 7,575,933.
Application No. 11/139,184 is a continuation of application No. 10/388,701, filed on Mar. 14, 2003, now Pat. No. 6,905,655.
Application No. 10/388,701 is a continuation-in-part of application No. 10/099,664, filed on Mar. 15, 2002, now Pat. No. 7,312,095.
Application No. 10/099,664 is a continuation-in-part of application No. 11/090,550, filed on Mar. 25, 2005.
Application No. 11/090,550 is a division of application No. 10/280,265, filed on Oct. 26, 2002, now Pat. No. 6,894,359.
(60) Provisional application No. 60/723,530, filed on Oct. 3, 2005.
(60) Provisional application No. 60/748,834, filed on Dec. 9, 2005.
(60) Provisional application No. 60/504,663, filed on Sep. 18, 2003.
(60) Provisional application No. 60/366,566, filed on Mar. 22, 2002.
(60) Provisional application No. 60/408,412, filed on Sep. 4, 2002.

(51) Int. Cl. C40B 60/12

(52) U.S. Cl. 506/39

(57) ABSTRACT

A detector system is described including arrays having a plurality of nanoelectronic sensors comprising a channel including a nanostructured element disposed on a substrate, the nanostructured element functionalized by one or more materials disposed on or adjacent to the nanostructured element so as to operatively influence one or more sensor electrical properties. In certain embodiments, the nanostructured element comprise one or more nanotubes, and the functionalization material may include nanoparticles composed of one or more metals, metal oxides, salts, or other inorganic or organic materials or composites of these.

In one exemplary embodiment, an array includes plurality of sensors which are configured as field effect transistors, the nanostructured element comprising a randomly dispersed interconnecting network of single-walled carbon nanotubes (SWNTs) having semiconducting properties, and functionalized by deposition of metallic nanoparticles comprising one or more metallic elements. The deposition of nanoparticles may be controlled to preserve semiconductive properties of the nanotubes. Novel methods of electrodeposition of such nanoparticles are described.

The detector system may be configured to distinguish and detect a range of different analyte species by measurement of the responses of a plurality of sensors of the array, and analyzing the measurements using principal component analysis, pattern-recognition analysis tools, and the like. Example analytes may comprise a plurality of organic and inorganic gases, such as are relevant to medical, industrial, environmental and security detection.

### CROSS-REFERENCE TO RELATED APPLICATION

This application claims priority pursuant to 35 USC. §119(e) to the following U.S. Provisional Applications No. 60/723,530 filed Oct. 3, 2005 entitled “Sensor Array based on metal decorated carbon nanotubes”; and No. 60/748,834 filed Dec. 9, 2005 entitled “Nanoelectronic Sensors Having Substrates With Pre-Patterned Electrodes, And Environmental Ammonia Control System” which applications are by reference.

This application is a continuation-in-part of and claims priority to U.S. patent application Ser. No. 10/945,803 filed Sep. 20, 2004 entitled “Multiple nanoparticles electrode posited on nanostructures” (publication 2005-0157,445); which claims which claims the priority of U.S. Provisional Application No. 60/504,663 filed Sep. 18, 2003; which applications are incorporated by reference.

This application is a continuation-in-part of and claims priority to U.S. patent application Ser. No. 11/488,456 filed Jul. 18, 2006 entitled “Improved Carbon Dioxide Nanosensor, And Respiratory CO2 Monitors” (published as 2006-______), which claims priority to Provisional Applications No. 60/531,079 filed Dec. 18, 2003, and No. 60/564,248 filed Apr. 20, 2004, and which is a continuation-in-part of patent application Ser. No. 10/940,324 filed Sep. 13, 2004 and Ser. No. 10/656,898 filed Sep. 5, 2003, which applications are incorporated by reference.

This application is a continuation-in-part of and claims priority to U.S. patent application Ser. No. 11/139,184 filed May 27, 2005 entitled “Modification Of Selectivity For Sensing For Nanostructure Device Arrays”, which is a continuation of Ser. No. 10/388,701 filed Mar. 14, 2003 (now U.S. Pat. No. 6,905,655), which claims the priority of U.S. Provisional Application No. 60/366,566 filed Mar. 22, 2002, and which also is a continuation-in-part of U.S. patent application Ser. No. 10/099,664 filed Mar. 15, 2002; which applications are incorporated by reference.

This application is a continuation-in-part of and claims priority to U.S. patent application Ser. No. 11/090,550 filed Mar. 25, 2005 entitled “Sensitivity Control For Nanotube Sensors”, which is a divisional of Ser. No. 10/280,265 filed Oct. 26, 2002 (now U.S. Pat. No. 6,894,359), which claims priority to U.S. Provisional Patent Application No. 60/408,412 filed Sep. 4, 2002; which applications are incorporated by reference.

### POTENTIAL GOVERNMENT RIGHTS

The subject matter of this application was partially supported by EPA SBIR grant EP-D04-045. The Government may have certain rights to this invention.

### BACKGROUND OF THE INVENTION

1. Field of the Invention

The present invention relates to sensor systems and particularly to electrical sensor devices using nanostructures, for example, nanotubes or nanowires, as a conductive element.

2. Description of Related Art

Sensor arrays, sometimes called “electronic noses,” can mimic nature by combining artificial computational capability and pattern-recognition-based sensing architectures. A sensor array may achieve selectivity by providing a characteristic signature for an analyte derived from the global response of the sensors contained within the array. Sensor modalities have included surface acoustic wave and bulk resonating quartz crystal devices, micro-machined cantilevers, conducting polymers, semiconducting metal oxide resistors, semiconductor field-effect transistors, and carbon black-polymer composites. See, for example, J. W. Gardner et al., “Electronic Noses: Principles and applications”, Oxford University Press: Oxford UK, 1999; K. J. Albert et al., “Cross-Reactive Chemical Sensor Arrays” Chem. Rev. 2000, 100, 2595; P. C. Jurs et al., “Computational Methods for the Analysis of Chemical Sensor Array Data from Volatile Analytes” Chem. Rev. 2000, 100, 2649; and J. R. Stetter et al, “Understanding chemical sensors and chemical sensor arrays (electronic noses): Past, present, and future”, Chapter 2.3 in Sensor Update, Vol. 10, Wiley-VCH, Weinheim, Germany, pp. 189-229, 2002; each of which publication is incorporated by reference.

Integration of sensor elements into a complex sensor array may bring about “electronic noses” as complex as the mammalian olfactory system. See, for example, P. Mombaerts, “Seven-transmembrane proteins as odorant and chemosensory receptors”, Science 1999, 286, 707; K. Mori, et al., “The olfactory bulb: coding and processing of odor molecule information”, Science 1999, 286, 711; and N. Sobel et al., “Olfaction: The world smells different to each nostril” Nature 1999, 402, 35; each of which publication is incorporated by reference.

Artificial olfaction or electronic nose systems have been adapted for use in industrial quality control applications, such as in the food processing industry, and particularly in applications which justify the installation of relatively high-cost and complex instrumentation. See, for example, the Fox sensor system made by Alpha M.O.S. of Toulouse, France. Attempts have been made to develop electronic nose systems for medical applications as well. See, for example, U.S. Pat. No. 6,620,107 entitled “Detection of conditions by analysis of gases or vapours”; U.S. Pat. No. 6,319,724 entitled “Trace level detection of analytes using artificial olfactometry”; and U.S. Pat. No. 6,455,319 entitled “Use of spatiotemporal response behavior in sensor arrays to detect analytes in fluids”; each of which patent is incorporated by reference.

Electronic devices using nanostructured elements or “nanostructures”, such as carbon nanotubes and silicon nanowires, have been configured as transistors, optoelectronic devices, sensors, and the like. For example, devices comprising active elements comprising carbon nanotubes, have been demonstrated as chemical sensors, as in U.S. Pat. No. 6,528,020 entitled “Carbon Nanotube Devices”, which patent is incorporated by reference.

### SUMMARY OF THE INVENTION

A first embodiment of a sensor array systems includes a plurality of nanoelectronic sensors configured to produce a plurality of different responses to a analyte. The system includes a processing configured to receive signals in response to exposure of the sensor array to a sample medium, and to apply one or more algorithms to recognize a characteristic signature for the analyte. The processing unit may be configured to apply pattern-recognition-based signal processing so as to function as a “electronic nose.”

One embodiment of a sensor device suited for employment in the inventive sensor arrays is described and comprises a channel including a nanostructured element disposed on a substrate, the nanostructured element functionalized by the deposition or reaction of one or more materials disposed on or adjacent to the nanostructured element so as to operatively influence one or more electrical properties. In certain embodiments, the nanostructured element may comprise one or more nanotubes, and the functionalization material may include nanoparticles composed of one or more metals, metal oxides, salts, or other inorganic or organic materials or composites of these.

In one exemplary embodiment, an array includes plurality of sensors which are configured as field effect transistors, the nanostructured elements comprising a randomly dispersed interconnecting network of single-walled carbon nanotubes (SWNTs) having semiconducting properties, and functionalized with metallic nanoparticles, in which the nanoparticles comprise one or more of a range of metallic elements. The amount of nanoparticles may be controlled to preserve semiconductive properties of the nanotubes, and the substrate immediately adjacent to the nanotubes may remain substantially free of nanoparticles. Novel methods of electrodeposition of such nanoparticles are described.

In alternative exemplary embodiments, an array includes a plurality of sensors which having functionalization including non-metallic organic and/or inorganic materials, such as a polymer, biomolecules, and the like.

In alternative exemplary embodiments, an array includes a plurality of sensors configured to detect capacitive, impedance, electrochemical and other sensor properties, in addition or in substitution to transconductance or amphometric properties.

The detector system may be configured to distinguish and detect a range of different analyte species by measurement of the responses of a plurality of sensors of the array, and analyzing the measurements using principal component analysis, pattern-recognition analysis tools, and the like. In one example, the analytes comprise a plurality of organic and inorganic gases. The small-size, low-power, electronic sensor arrays have applications in fields such as medical, industrial, environmental and security detection.

In certain embodiments, nanostructures are functionalized by electro-deposition of metallic material. The invention provides electronic devices comprising nanostructures on substrates with nanoparticles deposited in a controlled pattern over the substrate and nanostructures. The deposition pattern may comprise features that are too fine to be defined using conventional lithography, for example, individual nanostructures may be deposited with nanoparticles while immediately adjoining regions of the substrate are not. The nanoparticles may comprise the same material, or different materials. Different nanoparticle materials may be deposited in succession, or at approximately the same time.

According to an embodiment of the invention, nanoparticles are deposited on or adjacent to nanostructures disposed on a substrate by electrodeposition from a solution. By controlling the parameters of the electrodeposition process, materials in the solution may be caused to deposit as nanoparticles primarily on the nanostructures, or generally in contact with the nanostructures. Different materials may be deposited from the same solution, or from a succession of different solutions. The geometry of the nanostructures in the nanoelectronic devices on the substrate may be used to create different types of deposition patterns, such as clusters of nanoparticles at particular locations; a layered structure with each layer comprising a different material; nanoparticles of different materials in different regions; or the like. Embodiments of the invention include structures with nanoparticles of metals, metal oxides, and salts. For example, embodiments may include nanoparticles of Ag, Au, Ir, Ni, Os, Pd, Pt, Rh, and Ru.

Referenced is made for further description of electrodeposition methods and additional aspects of sensor devices to co-invented U.S. patent application Ser. No. 10/945,803 filed Sep. 20, 2004 entitled “Multiple nanoparticles electrodeposited on nanostructures” (publication 2005-0157,445), which is incorporated by reference and which should be read and understood in conjunction with the present application.

One embodiment of a nanosensor array system having aspects of the invention for detecting an analyte in a liquid or gaseous medium, comprises a plurality of sensor devices including at least a first device and a second sensor device. The first device may comprise at least one nanostructured element disposed on a substrate, and at least one first recognition material operatively associated with the at least one nanostructure element, the first recognition material having a first composition configured to interact with an analyte of interest so as to change an electrical property of the nanostructured element, thereby producing a first response signal. The second device may comprise second device comprising at least one nanostructured element disposed on a substrate, and at least one second recognition material operatively associated with the at least one nanostructure element, the second recognition material having a second composition configured to interact with an analyte of interest so as to measurably change an electrical property of the nanostructured element, thereby producing a second response signal, wherein the first recognition material composition and the second recognition material composition are selected to produce measurable different first and second response signals. The array system may further comprise processing circuitry in communication with the plurality of devices so as to receive the first and second response signals, and configured to detect the analyte by analyzing a pattern comprising the first and second response signals.

In certain embodiments of the nanosensor array system, the recognition material comprises one or more of a metal, a metal oxide, and a metal salt. In certain embodiments, the recognition material comprises one or more nanoparticles disposed in contact with the nanostructured element. The nanoparticle may be formed, at least in part, by electrodeposition of a metal from a solution in contact with the nanostructured element. The metal may include at least one of Mg, Al, Ti, V, Cr, Mn, Fe, Co, Ni, Zn, Mo, Rh, Pd, Sn, W, Pt, Pb, Au, Cu, Ir, Ru, Os, Ag, and the like.

In alternative embodiments of the nanosensor array system, the recognition material comprises a polymer, which may optionally be associated with nanoparticles. For example, see polymers and other recognition materials described in U.S. patent application Ser. No. 11/488,456 filed Jul. 18, 2006 entitled “Improved Carbon Dioxide Nanosensor, And Respiratory CO2 Monitors” (published as 2006-______), which application is incorporated by reference.

In certain embodiments of the nanosensor array system, the nanostructured element of a sensor device comprises one or more carbon nanotubes. The nanostructured element may comprise a plurality of carbon nanotubes configured as an interconnecting network wherein the interconnections between nanotubes provide electrical conductivity through the network.

In certain embodiments of the nanosensor array system, the processing circuitry is configured to detect the analyte by at least applying one of Principal Component Analysis and Partial Least Squares Regression.

### BRIEF DESCRIPTION OF THE DRAWINGS

FIG. 1 is a schematic diagram showing an exemplary nanostructure sensor having aspects of the invention.

FIG. 2 shows a first example of the NTFET device characteristics for an exemplary sensor including thermal evaporation of discontinuous layer of gold.

FIGS. 3A-3D show further examples of the sensor response of several NTFET devices upon exposure to H₂, CH₄, CO and H₂S.

FIGS. 4A-4D illustrate the response of sensors such as shown in FIG. 3, but having a greater range of different metallic functionalization.

FIG. 5 is an scanning electron micrograph showing a nanotube network having electrodeposited metallic nanoparticles.

FIGS. 6A-C illustrate three levels of detail and integration of an exemplary sensor array system having aspects of the invention.

FIGS. 7A-7D show measurements illustrating electronic characteristics of the sensor regions of the device of FIGS. 6A-C upon exposure to H₂, H₂S, NH₃ and NO₂.

FIGS. 8A-8C shows results of Principal Component Analysis of the responses of sensors such as shown in FIG. 3 to five gas analytes.

FIGS. 9A-9D show shows results of Partial Least Squares (PLS) Regression of the responses of sensors such as shown in FIG. 3 to four gas analytes.

### DETAILED DESCRIPTION OF THE PREFERRED EMBODIMENT

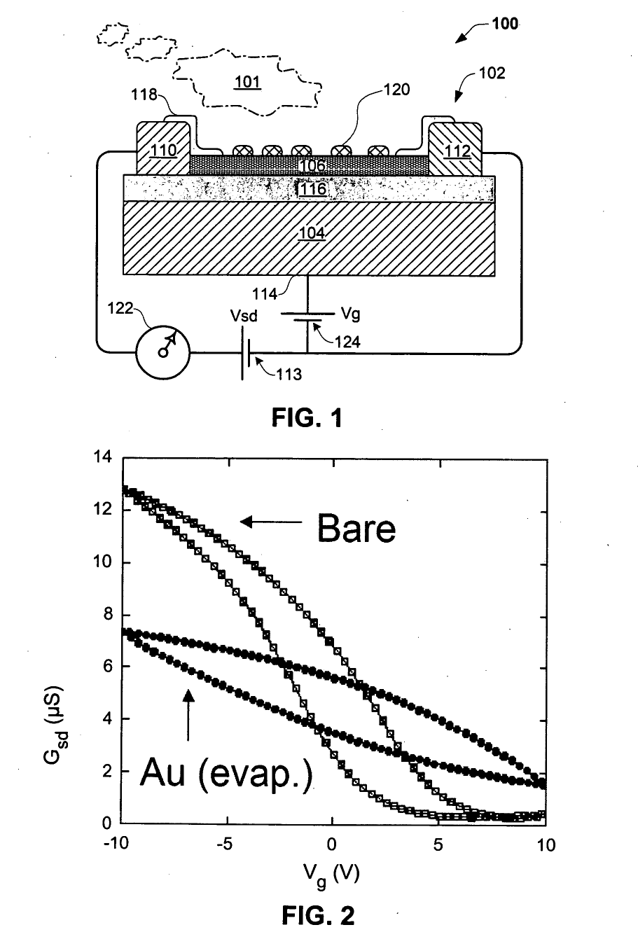

FIG. 1. shows an exemplary electronic sensing device 100 having aspects of the invention, for detecting an analyte 101 (e.g. H₂, NH₃, NO, and the like), comprising a nanostructure sensor 102. Sensor 102 comprises a substrate 104, and a conducting (e.g., semiconducting) channel or layer 106 comprising one or more nanostructured elements, such as a nanotube or network of nanotubes, disposed on the substrate. The nanostructure material 106 may contact the substrate as shown, or in the alternative, may be spaced a distance away from the substrate, with or without a layer of intervening material.

One or more conductive elements or contacts 110, 112 may be disposed over the substrate and electrically connected to conducting channel 106 comprising a nanostructure material. Elements 110, 112 may comprise metal electrodes in contact with conducting channel 106. In the alternative, a conductive or semi-conducting material (not shown) may be interposed between contacts 110, 112 and conducting channel 106. Contacts 110, 112 may comprise source and drain electrodes, respectively, upon application of a source-drain voltage Vsd. The voltage or polarity of source 110 relative to drain 112 may be variable, e.g., the applied voltage may be DC, AC, pulsed, or variable. In an embodiment of the invention, the applied voltage is a DC voltage.

In an embodiment of the invention, conducting channel 106 may comprise a plurality of carbon nanotubes forming a mesh, film or network. Such a network may be formed by various suitable methods. One suitable approach may comprise forming an interconnecting network of single-wall carbon nanotubes directly upon the substrate, such as by reacting vapors in the presence of a catalyst or growth promoter disposed upon the substrate. For example, single-walled nanotube networks can be grown on silicon or other substrates by chemical vapor deposition from iron-containing catalyst nanoparticles with methane/hydrogen gas mixture at about 900° C. Advantageously, the use of highly dispersed catalyst or growth-promoter for nanostructures permits a network of nanotubes of controlled diameter and wall structure to be formed in a substantially random and unclumped orientation with respect to one another, distributed substantially evenly at a selected mean density over a selected portion of the substrate.

Alternatively, a nanotube network may be deposited on a device substrate by spray deposition and the like. For example, single wall carbon nanotubes (SWNTs) and/or other nanoparticles may be suspended in a suitable fluid solvent, and sprayed, printed or otherwise deposited in a substrate. The SWNTs or other nanoparticles may optionally have additional functionalization groups, purification and/or other pre-deposition processing. For example SWNTs functionalized with poly m-aminobenzene sulfonic acid (PABS) show hydrophilic properties and may be dispersed in aqueous solutions.

One or more conductive traces or electrodes may be deposited after deposition, or alternatively, the substrate may include pre-patterned electrodes or traces exposed on the substrate surface. Similarly, alternative embodiments may have a gate electrode and a source electrode supported on a single substrate. The substrate may include a flat, sheet-like portion, although one skilled in the art will appreciate that geometric variations of substrate configurations (rods, tubes or the like) may be employed without departing from the spirit of the inventions.

Multiple light, uniform spray steps may be performed, e.g., with drying and resistance testing between spray steps) until the network sheet resistance reaches a target value (implying a target network density and conductivity). In one example, P2-SWNTs produced by Carbon Solutions, Inc of Riverside, Calif. were spray-deposited on a portion of a PET sheet substrate with pre-patterned traces until a sheet resistance about 1 kΩ was reached.

See also the methods for making nanotube networks as well as additional device and substrate alternatives as described the following patent applications, each of which is incorporated by reference:
U.S. patent application Ser. No. 10/177,929 filed Jun. 21, 2002 entitled “Dispersed Growth Of Nanotubes On A Substrate”, (PCT equivalent published as WO04-040,671);
U.S. application Ser. No. 10/846,072 filed May 14, 2004, entitled “Flexible nanotube transistors” (Publication 2005-0184,641);
U.S. patent application Ser. No. 11/274,747 filed Nov. 14, 2006 entitled “Nanoelectronic Glucose Sensors”; and
U.S. Patent Application No. 60/748,834, filed Dec. 9, 2005, entitled “Nanoelectronic Sensors Having Substrates With Pre-Patterned Electrodes, And Environmental Ammonia Control System”.

In addition to nanotube films or networks, films or other arrangements of other nanostructures, including individual nanostructures, can be used. Alternative nanostructures may include, for example, nanospheres, nanocages, nanococoons, nanofibers, nanowires, nanoropes and nanorods. Such alternative nanostructures may be adapted similarly to nanotubes for the embodiments described herein. Nanostructures can be made of many different elements and compounds. Examples include carbon, boron, boron nitride, and carbon boron nitride, silicon, germanium, gallium nitride, zinc oxide, indium phosphide, molybdenum disulphide, and silver.

In the example of FIG. 1, the device 100 may be operated as a gate-controlled field effect transistor, with sensor 102 further comprising a gate electrode 114. Such a device is referred to herein as a nanotube field effect transistor or NTFET. Gate 114 may comprise a base portion of substrate 104, such as a doped-silicon wafer material isolated from contacts 110, 112 and channel 106 by a dielectric layer 116, so as to permit a capacitance to be created by an applied gate voltage V_{g}. For example, the substrate 104 may comprise a silicon back gate 114, isolated by a dielectric layer 116 comprising SiO₂. Alternatively gate 114 may include a separate counter electrode, liquid gate or the like.

Sensor 102 may further comprise a layer of inhibiting or passivation material 118 covering regions adjacent to the connections between the conductive elements 110, 112 and conducting channel 106. The inhibiting material may be impermeable to at least one chemical species, such as to the analyte 101 or to environmental materials such as water or other solvents, oxygen, nitrogen, and the like. The inhibiting material 118 may comprise a passivation material as known in the art, such as silicon dioxide, aluminum oxide, silicon nitride, or other suitable material. Further details concerning the use of inhibiting materials in a NTFET are described in prior co-invented U.S. Pat. No. 6,894,359 entitled “Sensitivity Control For Nanotube Sensors” which is incorporated by reference herein.

Device 100 may further comprise suitable circuitry in communication with sensor elements to perform electrical measurements. For example, a conventional power source may supply a source drain voltage V_{sd} (113) between contacts 110, 112. Measurements via the sensor device 100 may be carried out by circuitry represented schematically by meter 122 connected between contacts 110, 112. In embodiments including a gate electrode 114, a conventional power source 124 may be connected to provide a selected or controllable gate voltage V_{g}. Device 100 may include one or more electrical supplies and/or a signal control and processing unit (not shown) as known in the art, in communication with the sensor 102.

Optionally, device 100 may comprise a plurality of sensors like sensor 102 disposed in a pattern or array, such as described in prior application Ser. No. 10/388,701 filed Mar. 14, 2003 entitled “Modification Of Selectivity For Sensing For Nanostructure Device Arrays” (now published as US 2003-0175161), which is incorporated by reference herein. Each device in the array may be functionalized with identical or different functionalization. Identical device in an array can be useful in order to multiplex the measurement to improve the signal/noise ratio or increase the robustness of the device by making redundancy. Different functionalization may be useful for providing differential sensitivity so as to permit measurement of a profile of different responses to analytes.

The substrate 104 may be insulating, or on the alternative, may comprise a layered structure, having a base 114 and a separate dielectric layer 116 disposed to isolate the contacts 110, 112 and channel 106 from the substrate base 114. The substrate 104 may comprise a rigid or flexible material, which may be conducting, semiconducting or dielectric. Substrate 104 may comprise a monolithic structure, or a multilayer or other composite structure having constituents of different properties and compositions. For example, in an embodiment of the invention, the substrate 104 may comprise a silicon wafer doped so as to function as a back gate electrode 114. The wafer being coated with intermediate diffusion barrier of Si₃N₄ and an upper dielectric layer of SiO₂. Optionally, additional electronic elements may be integrated into the substrate for various purposes, such as thermistors, heating elements, integrated circuit elements or other elements.

In certain alternative embodiments, the substrate may comprise a flexible insulating polymer, optionally having an underlying gate conductor (such as a flexible conductive polymer composition), as described in application Ser. No. 10/846,072 filed May 14, 2004, which application is incorporated by reference. In further alternative embodiments, the substrate may comprise a polymeric substance coated with nanotube or other nanostructure particles in the in the manner described in U.S. application Ser. No. 11/274,747 filed Nov. 14, 2005, which application is incorporated by reference.

The conducting channel 106 (e.g., a carbon nanotube layer) may be functionalized to produce a sensitivity to one or more target analytes 101. Although nanostructures such as carbon nanotubes may respond to a target analyte through charge transfer or other interaction between the device and the analyte, more generally a sensitivity can be achieved by employing a recognition material 120, also called a functionalization material, that induces a measurable change in the device characteristics upon interaction with a target analyte. In addition or in substitution to the metallic nanoparticle functionalization, of the exemplary embodiments described in detail herein, the functionalization may alternatively include metal oxides, metal salts, polymers, and the like. Likewise, functionalization may include composite nanoparticles, mixtures of materials or the like.

In the exemplary embodiments described in detail herein, the recognition material disposed upon the channel 106 comprises on or more metallic materials. In particular, alternative embodiments of arrays of sensors such as shown in FIG. 1 may be functionalized with a range of materials different catalytic metals to produce cross-sensitive NTFET sensor elements.

### Example 1

In this example, NTFET devices were fabricated using SWNTs grown via chemical vapor deposition (CVD) at 900° C. using dispersed iron nanoparticles as growth promoter and a methane/hydrogen gas mixture on doped Si 100 mm wafers with SiO₂ at its surface. Electrical leads were patterned on top of the nanotubes from Ti films 30 nm thick capped with an Au layer of 120 nm thick using standard photolithography techniques. Each wafer consists of about one thousand dice with 2.54×2.54 mm² dimensions. On each die, random network of SWNTs is patterned into several devices (50×500 μm² and 25×500 μm²) that consist of two parallel electrodes (See the structure shown in FIG. 1). Carbon nanotubes outside the device areas were removed using oxygen plasma to electrically isolate each device. Scanning electron microscopy (SEM) was used for process quality assurance; NTFET electronic characteristics were collected using a custom-made autoprobe tester. Transfer characteristics, i.e., source-drain conductance versus gate voltage, G-Vg, were measured in air with the gate voltage applied to the doped Si substrate and were consistent with p-type, positive threshold voltages, as described elsewhere. [see J-C P Gabriel et al, “Large Scale Production of Carbon Nanotube Transistors: A Generic Platform for Chemical Sensors”, Mater Re Soc Symp Proc (2003) 776, Q12.7.1, which is incorporated by reference].

The NTFET devices in this example, were decorated by thermal and electron-beam evaporation of Mg, AI, Ti, V, Cr, Mn, Fe, Co, Ni, Zn, Mo, Rh, Pd, Sn, W, Pt, Au and Pb metals. Each of the NTFET devices on the Si chip were decorated with a specific metal. Evaporation was performed using Edward Auto 306 e-beam evaporator to a nominal thickness of ˜10 Å. Metal targets were purchased from Aldrich.

FIG. 2 shows a first example of the NTFET device characteristics for an exemplary NTFET sensor such as shown in FIG. 1 including thermal evaporation of discontinuous layer of gold (Au evap), compared to the device characteristics of the device without metal deposition on the nanotube network (“bare”). The plot shows the G-Vg transfer curve, i.e., source-drain conductance (G) as a function of applied gate voltage (Vg). The conductance of the device having AU deposition is shown to be less sensitive to gate voltage than the “bare” device.

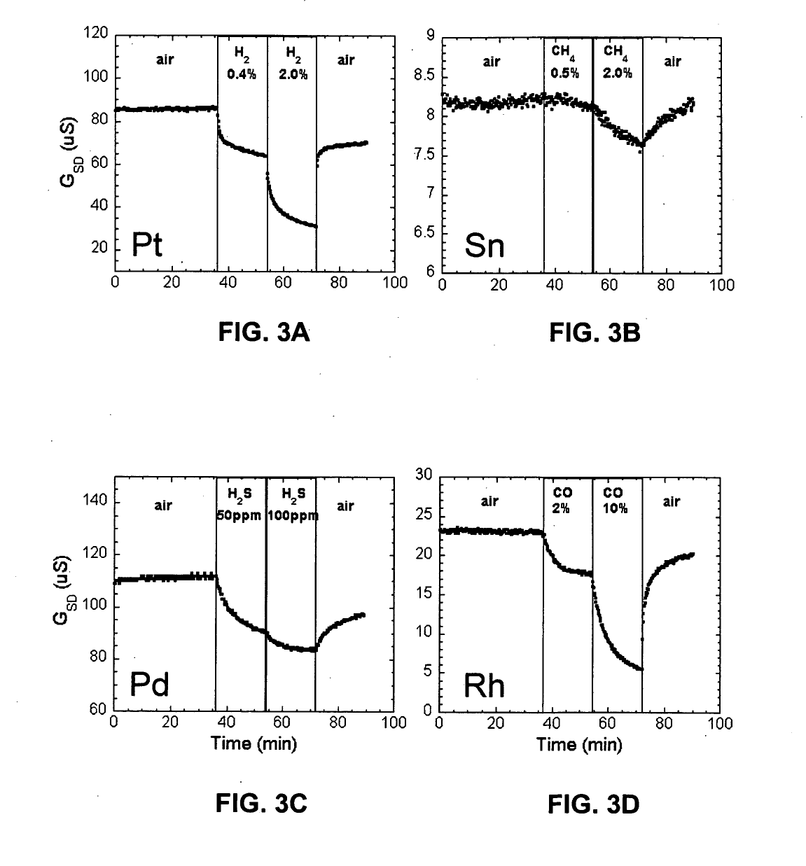

FIGS. 3A-3D show further examples of the sensor response of several NTFET devices such as shown in FIG. 1, each having a channel 106 comprising a nanotube network including functionalization 120 comprising a discontinuous layer of an elemental metal. The metals were evaporated on a chip with nanotube devices by thermal or e-beam evaporation. The chips with the metal functionalized sensors were packaged and tested with four combustible gases: H₂, CH₄, CO and H₂S. The gas testing was done in air at room temperature, at constant relative humidity. Each gas was introduced at two concentrations for 18 minutes each, at room temperature and at zero gate voltage. FIG. 3A shows the response of a PT functionalized sensor to H₂ (0.4% and 2% in air); FIG. 3B shows the response of a Sn functionalized sensor to CH₄ (0.5% and 2% in air); FIG. 3C shows the response of a Pd functionalized sensor to H₂S (50 ppm and 100 ppm in air); and FIG. 3A shows the response of a Rh functionalized sensor to CO (2% and 10% in air).

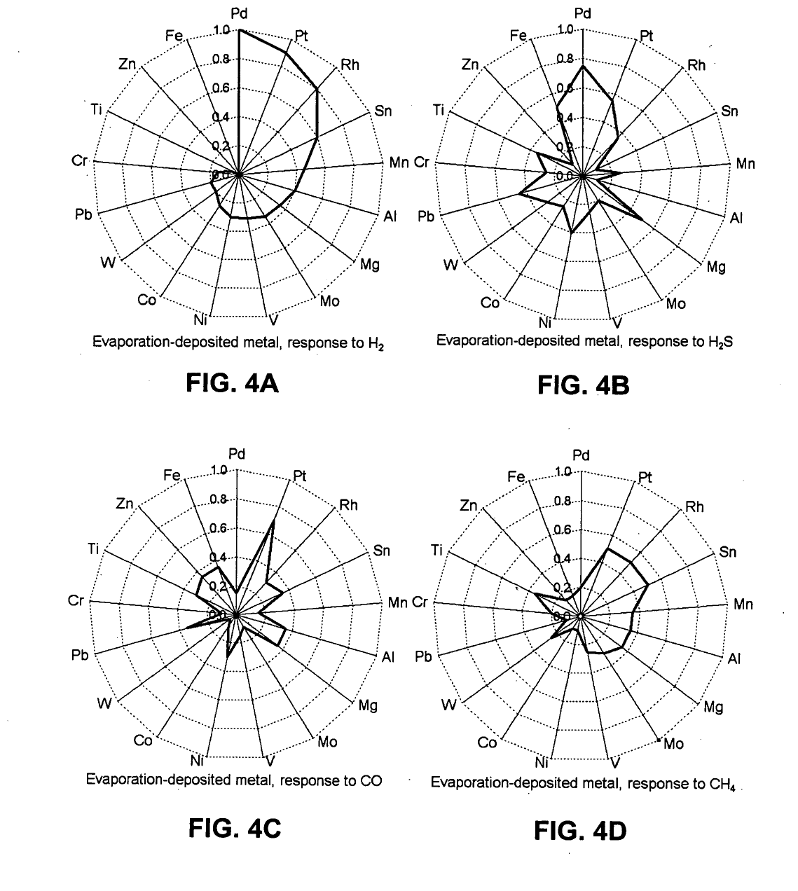

FIGS. 4A-4D illustrate the response of sensors prepared as in FIG. 3, but having a greater range of different metallic functionalization. The metals were evaporated on a chip with nanotube devices by thermal or e-beam evaporation. The electronic response of metal coated NTFET devices to all four combustible gases was similar: The presence of the combustible gas in air resulted in decrease of the device conductance. However, the response—both the magnitude of response and response time—were different for each tested gas/metal coating combination.

FIGS. 4A-4D show calculated correlation coefficients—goodness-of-fit measure between the device conductance and the tested gas profile, so as to quantify how well certain gas was detected at the tested conditions. Each figure shows the responses of sensors to a different gas analyte, each figure being a radial plots comparing the response to 17 sensors each having functionalization of one of the following metals: Mg, Al, Ti, V, Cr, Mn, Fe, Co, Ni, Zn, Mo, Rh, Pd, Sn, W, Pt, or Pb.

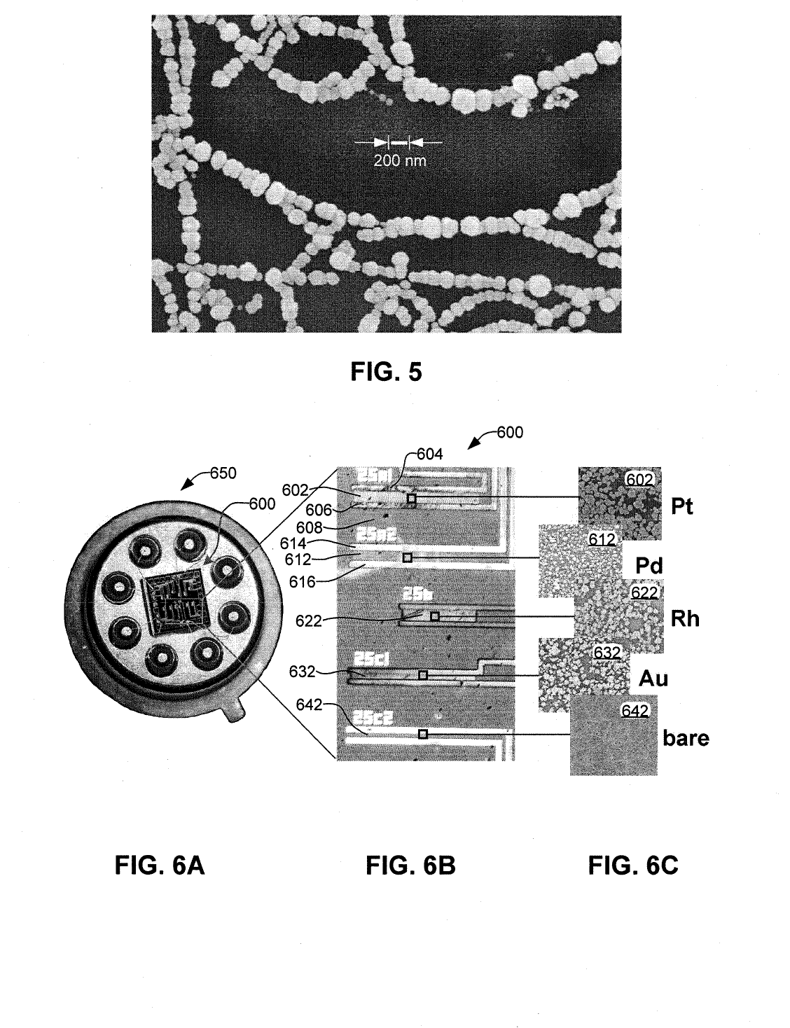

The sensor response values (conductance at zero gate voltage) are shown for exposure to H₂, CH₄, CO and H₂S under the conditions employed in the example of FIGS. 5A-5D, and were normalized by the highest response level (a Pt decorated sensor exposed to H₂), from 0 (no response) to 1 (maximal response). In the axial position of each metal response is in each of FIGS. 4A-4D is ordered in order of the response level of the Pt decorated sensor exposed to H₂ as well. Each gases may be seen to produce a distinct and different profile of relative sensor response. One of ordinary skill in the art will see that a selected plurality of the metals shown in FIGS. 4A-4D may be included as catalyst functionalization of different sensor devices of an array, so as to produce signals from which the analyte concentrations may be measured and the different analytes distinguished, either for the gas analytes shown, or other organic and inorganic analytes in like manner.

### Example 2

In this example, NTFET devices were fabricated in the manner described above with respect to Example 1, but having a metallic functionalization material configured by electrodeposition of nanoparticles in the manner described in co-invented U.S. patent application Ser. No. 10/945,803 filed Sep. 20, 2004 entitled “Multiple nanoparticles electrodeposited on nanostructures” (publication 2005-0157,445), which is incorporated by reference. FIG. 5 is an scanning electron micrograph showing a nanotube network having electrodeposited metallic nanoparticles.

Functionalization of an array of sensors can be accomplished electrochemically, using galvanic displacement, 1) connecting a specific sensor device on the chip to a metal substrate having a Red/Ox potential far lower than the metal to be deposited; and 2) immersing the device and substrate into a solution of the metal cation to be reduced and deposited which therefore closes the circuit of an electrochemical cell. By this method, selected NTFET sensor devices within an array of devices can be decorated with metal nanoparticles of chosen catalytic metal while leaving other adjacent devices unmodified.

The three connected view of FIGS. 6A-C illustrate three levels of detail and integration of an exemplary sensor array system 650 having aspects of the invention: a plurality of carbon nanotube network regions 602 to 642 as functionalized (FIG. 6C); a plurality of adjacent sensor devices of the array 600 (FIG. 6B); and the array chip 600 as packaged in a conventional IC package 650 for connection to measurement circuitry (FIG. 6A).

As shown in FIGS. 6A-6C, a chip 600 may be prepared having an array of electrodes forming the contacts for a plurality of adjacent nanotube network field-effect transistor (NTNFET) devices. Sensor chip 600 prepared according to example 1. Five different regions are shown in FIG. 6 At the top of the figure, a region 602 is deposited with Pt nanoparticles between electrodes 604, 606. An area of the substrate 608 that is substantially free of electrodes separates region 602 from an adjacent region 612. Region 612 lies between electrodes 614, 616, and is deposited with Pd nanoparticles. Chip 600 also includes an Rh-deposited region 622, an Au-deposited region 632, and a bare (undeposited) region 642. In this example, the nanostructure element (106 in FIG. 1) for every region on chip 600 comprises a single wall carbon nanotube network.

In the embodiment of Example 2, the nanotube network was prepared as described above with respect to Example 1 on a doped silicon substrate. A plurality of regions (e.g., 602 to 642) were defined by deposition of opposing space-apart pairs of titanium/gold electrodes acting as sources and drains spanning a nanotube network region (604-606; 614-616; etc.) are shown in FIG. 6B. A third electrode (not shown) was disposed in the conductive doped silicon substrate near the nanotube network film to act as a common gate electrode.

The nanotube transistor chip was placed on an aluminum block, and the block was electrically grounded. Metal pins were pushed onto two of the titanium/gold contacts on the nanotube chip related to a single NTNFET device, thus making electrical contact. These metal pins were electrically grounded. The chip was rinsed with a 1:1 mixture of water and ethanol for cleaning. A 5 mM solution of PdCl₂ in a 1:1 mixture of water and ethanol was prepared. Five drops of the solution were placed on the substrate, with the solution contacting both the substrate and the underlying aluminum block. After 30 seconds, the solution was rinsed off with a 1:1 mixture of water and ethanol, and the chip was dried with a stream of compressed air. This process was repeated for additional devices on the nanotube chip. The following 5 mM metal salt solutions (Na₃RhCl₆, Na₂PtCl₄, HAuCl₄) in a 1:1 mixture of water and ethanol were used on subsequent devices to functionalize with Rh, Pt, and Au, respectively. Selected devices of the array were left unmodified, so as to operate without functionalization material.

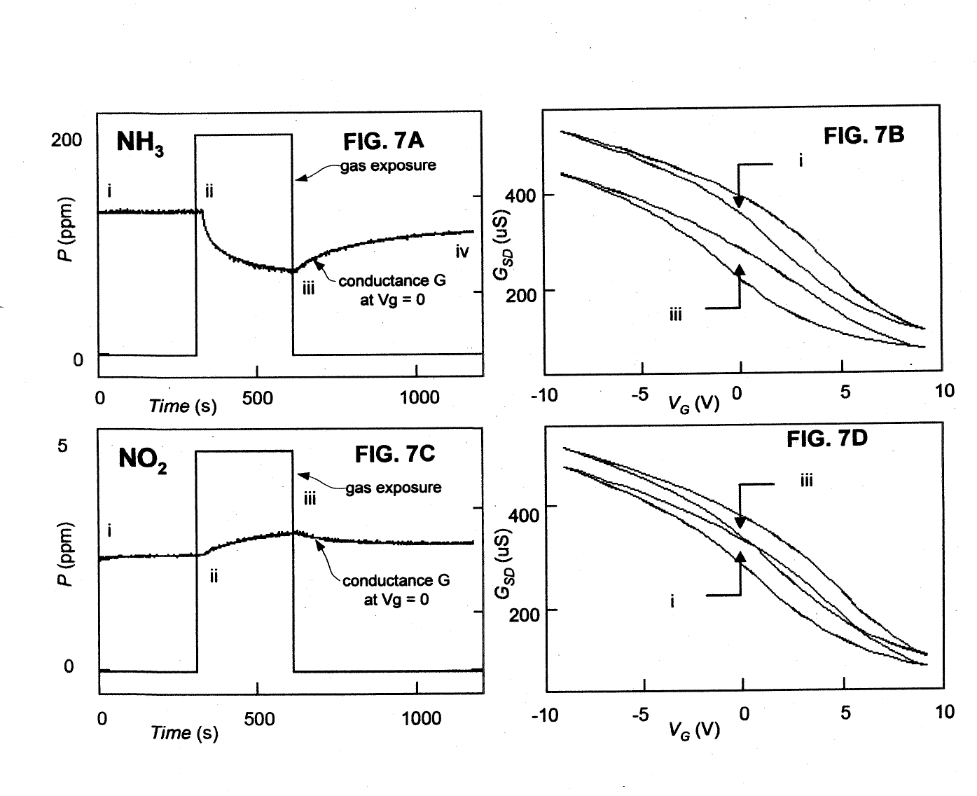

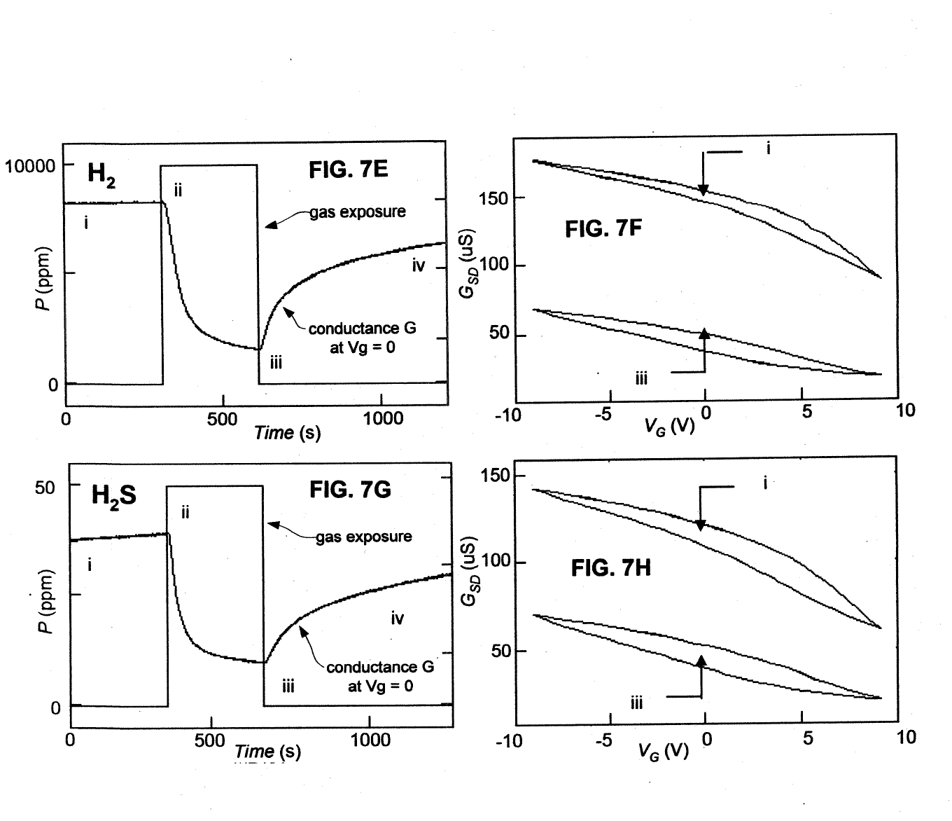

FIGS. 7A-7D show measurements illustrating typical electronic characteristics of the sensor regions (G-Vg measurements) of the device 600 upon exposure to exemplary analyte gases H₂, H₂S, NH₃ and NO₂. Each figure includes two views (1) and (2) respectively.

For each figure, view (1) plots both a single-pulse gas exposure profile (0 or maximum concentration, units in ppm) and a source-drain conductance signal (G at Vg=0). The exposure profile includes an initial 5-minute unexposed settling period (i-ii), a five-minute exposure response period (ii-iii), and a 10-minute recovery period (iii-iv).

For each figure, view (2) plots the device characteristics in the same conductance units for gate voltage Vg varied between −10 and 10 volts (note hysteresis), plotted both for initial unexposed period values (i) and the end of the response period (iii).

FIG. 7A shows the response of a bare (no electrodeposition) NTFET sensor (642) to a pulse of NH₃ at 200 ppm concentration. FIG. 7B shows the response of a bare NTFET sensor (642) to a pulse of NO₂ at 5 ppm concentration. FIG. 7C shows the response of a Pd-coated NTFET sensor (612) to a pulse of H₂ at 10,000 ppm concentration (1%). FIG. 7D shows the response of a Pd-coated NTFET sensor (612) to a pulse of H₂S at 50 ppm concentration.

The effect of NH₃ and NO₂ on devices including bare devices was a shift in device characteristics. Whereas exposure to NH₃ gas resulted in a shift to more negative Vg, adsorption of NO₂ gas on NTFET devices resulted in a shift to more positive values. Thus the shift can either decrease or increase of the device conductance as measured at zero gate voltage. The sensor results for NH₃ and NO₂ may be attributed to SWNT channel doping with either lone-pair electrons of NH₃ or holes resulting from NO₂ molecules.

On the other hand, the observed sensor response of metal-coated NTFET devices during exposures to H₂ and H₂S gases at room temperature (FIGS. 7C, 7D) was quite different: The device conductance decreases upon the gas exposure without any apparent shift in the G-Vg characteristics. The observed differences have certain ramifications on the undergoing sensor mechanism.

### Example 3

Sensor array systems having aspects of the invention may include data analysis algorithms directed to recognition and correlation of the profiles of response of a sensor array to an analyte. For example, the classical methods of Principal Component Analysis (PCA) and Partial Least Squares Regression (PLS Regression) may provide an efficient approach for reducing the dimensionality of a data set.

In this example, a sensor array was prepared as described in Example 2. Site-specific metal electrodeposition was used to deposit nanoparticles of different composition on different regions of nanotube films in adjacent sensor devices on a chip. Adjacent devices were thereby functionalized to respond differently to analytes. Control of the electrodeposition process was accomplished by grounding specific nanotube devices on the chip. The finished sensor array was demonstrated by passing different analytes over the surface of the sensor array. Measurement data from the array was then filtered and processed through principal component analysis (PCA) to recognize the signature associated with each gas analyte. The order of tests was randomized to separate the desired signal from the possible effects of drift and poisoning of the sensors and any changes in the gas delivery system. A single test consisted of a five-minute settling period, five-minute exposure to gas followed by a ten-minute recovery period. I−V_{G} measurements were taken continuously with gate voltage sweep frequency of 2 Hz and amplitude of 9V.

TABLE 1
Test Conditions

| Test gas | P, ppm |
|---|---|
| CO | 2500 |
| H₂ | 10000 |
| H₂S | 50 |
| NH₃ | 200 |
| NO₂ | 5 |

Responses of nine NTFET devices (channels) to sequence of 25 gas exposures (measured as device conductance at zero gate voltage). A single gas exposure consisted of a five-minute settling period, five-minute exposure to gas followed by a ten-minute recovery period. Measurements of 10 channels (two for each metal and two for bare NTFET devices) were made during the sequence of 25 gas exposures (CO, H₂, NH₃, H₂, H₂S, NO₂, NO₂, NO₂, H₂, H₂, NO₂, H₂S, NH₃, NH₃, H₂, H₂S, H₂S, CO, NO₂, CO, H₂S, NH₃, CO, NH₃, CO).

The analysis was performed with the aid of MINITAB (r) statistical software. To simplify data processing, we have examined the conductance at zero gate voltage. For data analysis purposes, the mean over the first 100 seconds of the test was used to represent the response to air, and the mean over the last 100 seconds of gas exposure was the response to the test gas in a given test.

The PCA method allows one to represent most of the variance in fewer dimensions. An ordered orthogonal basis is calculated, where the first basis vector corresponds to the largest variance in the original data, the second to the second largest variance and so on.

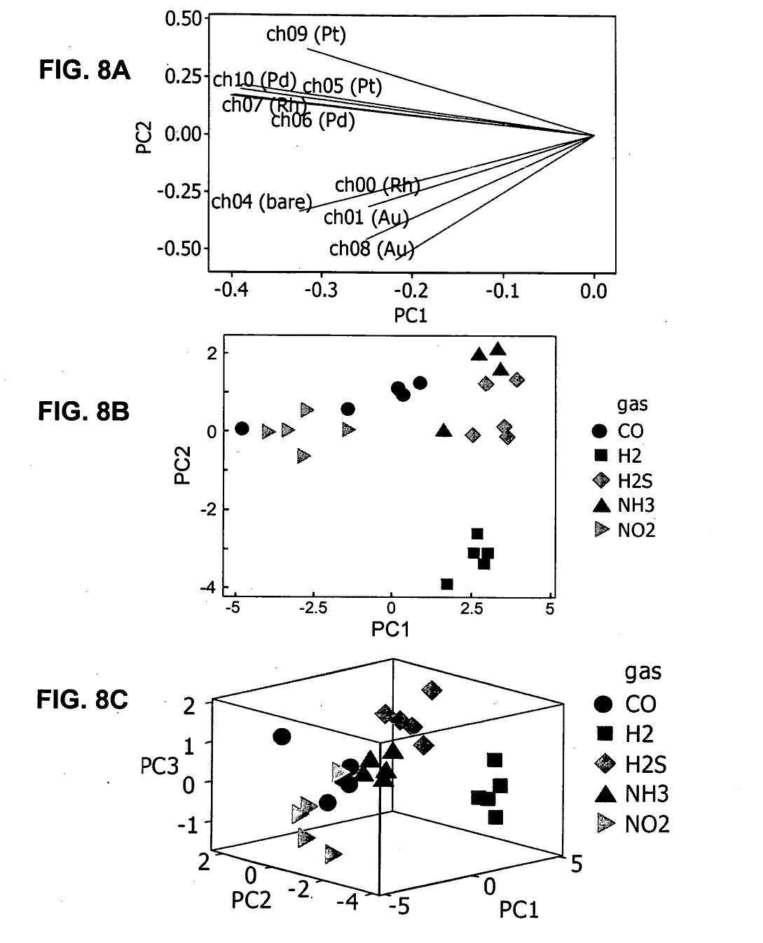

FIG. 8A Shows the loadings (coefficients) used to rotate the data, and indicate the relative importance of the original vectors. The scores on the vertical and horizontal axes represent the position of the data points in the new vector space. Typically, the scores for the first two components are plotted. However, in this example, the third component is still relatively important.

The two- and three-dimensional plots of scores are shown in FIGS. 8B and 8C, respectively. FIG. 8B shows PCA loadings of multiple measurement channels for the first two components. FIG. 8c shows scores as 3-D plot for the first three components. Points corresponding to zero test gas concentration are not shown for clarity (however, they were used in the analysis and affected the basis selection). The points corresponding to each five analytes are clustered in separate regions of the space of the first three principal components, demonstrating the effectiveness of the multi-analyte sensor.

A multivariate PLS regression model makes it possible not only to see whether the system has a distinct response to each analyte, but also to calculate the magnitude of the response in original units. The term multivariate is used to indicate multiple predictors and multiple responses. One of the main steps is that of data reduction, or variable selection. Different methods exist, many of which involve linear transformation of the predictor matrix and variable selection based on the transformed data. See, for example, N. R Draper et al., “Applied Regression Analysis”, 3rd edition, Wiley, New York, 1998, pp. 327-376, which is incorporated by reference. It is worth noting that the number of components in the model is not restricted, and the algorithm selected all nine principal components, which are linear transformations of data from the selected nine measurement channels. This means that in this case nothing was discarded from the original dataset and that the resulting model is identical to that of the classic multivariate linear regression.

Sensor array responses were measured to H₂, H₂S NO and NH₃ gas. In TABLE 2 are listed the PLS multiple correlation coefficients (R²), which were used as a simple goodness-of-fit measure, and their corresponding p-values, which indicate the probability of randomly obtaining the same or better fit.

TABLE 2

| Test gas | R2 | p-value |
|---|---|---|
| H₂ | 0.909 | 0.000 |
| H₂S | 0.842 | 0.000 |
| NH₃ | 0.769 | 0.000 |
| NO₂ | 0.684 | 0.000 |

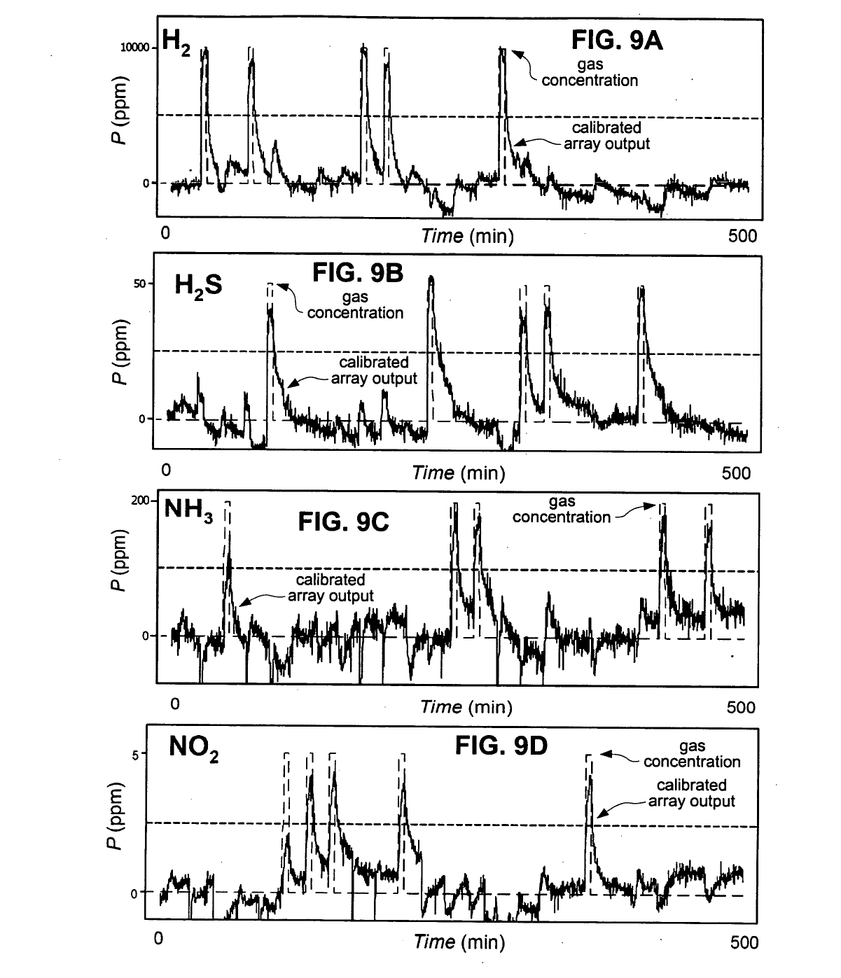

The resulting model was used to calculate the sensor array output signal for four analytes. FIGS. 9A-9D show the Partial Least Squares (PLS) Regression of the sensor array, wherein the dashed line show the gas concentration; the solid black line shows the calibrated output of sensor array. In summary, it will be recalled that individual NTFET channels are cross-sensitive to multiple gases (FIGS. 7-8), while the PLS output (FIG. 9) demonstrates selective responses of the sensor array for four gases from the sequence of 25 gas exposures.

In like fashion to that described in the examples above, correlation coefficients for other analyte substances may be measured, alternative functionalization materials and alternative device architectures may be included (e.g., alternative electrode elements and nanostructures, such as nanowires, MWNTs, non-carbon or hetero nanotubes other known nanoparticles, and the like). Such alternatives may include measurements of other device properties, such as capacitance, impedance and the like.

Having thus described a preferred embodiment of nanostructures with electrodeposited nanoparticles, and methods of making them, it should be apparent to those skilled in the art that certain advantages of the within system have been achieved. It should also be appreciated that various modifications, adaptations, and alternative embodiments thereof may be made within the scope and spirit of the present invention. For example, specific examples have been illustrated for nanotube film nanostructures, but it should be apparent that the inventive concepts described above would be equally applicable to other types of nanostructures. The invention is further defined by the following claims.

What is claimed is:

1. A nanosensor array system for detecting an analyte in a liquid or gaseous medium, comprising:
(a) a plurality of sensor devices including:
(i) at least a first device comprising at least one nanostructured element disposed adjacent a substrate, and at least one first recognition material operatively associated with the at least one nanostructure element, the first recognition material having a first composition configured to interact with an analyte of interest so as to change an electrical property of the nanostructured element, thereby producing a first response signal;
(ii) at least a second device comprising at least one nanostructured element disposed on a substrate, and at least one second recognition material operatively associated with the at least one nanostructure element, the second recognition material having a second composition configured to interact with an analyte of interest so as to measurably change an electrical property of the nanostructured element, thereby producing a second response signal;
(iii) wherein the first nanoparticle composition and the second nanoparticle composition are selected to produce measurably different first and second response signals;
(b) processing circuitry in communication with the plurality of devices so as to receive the first and second response signals, and configured to detect the analyte by analyzing a pattern comprising the first and second response signals.

2. The nanosensor array system of claim 1, wherein at least one of the first recognition material and the second recognition material one or more of a metal, a metal oxide, and a metal salt.

3. The nanosensor array system of claim 1, wherein at least one of the first recognition material and the second recognition material comprises one or more nanoparticles disposed in contact with the nanostructured element.

4. The nanosensor array system of claim 3, wherein the one or more nanoparticles comprises a metallic nanoparticle having a coating layer.

5. The nanosensor array system of claim 4, wherein the coating layer includes an oxide of the metal of the nanoparticle.

6. The nanosensor array system of claim 4, wherein the coating layer includes a polymer.

7. The nanosensor array system of claim 3, wherein the one or more nanoparticles is formed at least in part by electrodeposition of a metal from a solution in contact with the nanostructured element.

8. The nanosensor array system of claim 7, wherein the metal includes at least one of Mg, Al, Ti, V, Cr, Mn, Fe, Co, Ni, Zn, Mo, Rh, Pd, Sn, W, Pt, Pb, Au, Cu, Ir, Ru, Os, and Ag.

9. The nanosensor array system of claim 1, wherein the nanostructured element of at least one of the first and second devices comprises one or more carbon nanotubes.

10. The nanosensor array system of claim 9, wherein the nanostructured element comprises a plurality of carbon nanotubes configured as an interconnecting network wherein the interconnections between nanotube provide electrical conductivity through the network.

11. The nanosensor array system of claim 9, wherein the processing circuitry is configured to detect the analyte by at least applying one of analyzing Principal Component Analysis and Partial Least Squares Regression.
